(19) United States
(12) Patent Application Publication
(10) Pub. No.: US 2015/0136380 A1
(43) Pub. Date: May 21, 2015

(54) METHOD OF CONTROLLING VARIABLE DIVIDE COOLING SYSTEM FOR VEHICLE BASED ON MODE

(71) Applicants: Hyundai Motor Company, Seoul (KR); Kia Motors Corporation, Seoul (KR)

(72) Inventor: Hyun KIM, Hwaseong-si (KR)

(73) Assignees: Hyundai Motor Company, Seoul (KR); Kia Motors Corporation, Seoul (KR)

(21) Appl. No.: 14/281,563

(22) Filed: May 19, 2014

(30) Foreign Application Priority Data
Nov. 21, 2013 (KR) 10-2013-0142307

(51) Int. Cl. B60H 1/00

(52) U.S. Cl. CPC B60H 1/00007
USPC 165/253; 165/43

(57) ABSTRACT

A method of controlling a variable divide cooling system for a vehicle based on a mode may include classifying the mode for circulation control of a coolant of the variable divide cooling system into a heating mode, a warming-up mode, and a cooling mode, and performing the heating mode after an open-air temperature and a coolant temperature are checked when an engine is in a running state, and when a heater blower is turned on.

### CROSS-REFERENCE TO RELATED APPLICATIONS

The present application claims priority of Korean Patent Application Number 10-2013-0142307 filed on Nov. 21, 2013, the entire contents of which application are incorporated herein for all purposes by this reference.

### BACKGROUND OF INVENTION

1. Field of Invention

The present invention relates to a method of controlling a variable divide cooling system and, more particularly, to a method of controlling a variable divide cooling system for a vehicle based on a mode, capable of meeting heating requirements without degrading heating performance while maintaining performance of variable divide cooling control for improving engine efficiency and vehicle fuel economy.

2. Description of Related Art

In general, vehicles are provided with various apparatuses to improve fuel economy. Such apparatuses include, for example, a type using a cooling system to improve fuel economy. In the type using the cooling system, a temperature of an engine block is rapidly increased by a hot coolant, thereby reducing friction of a piston mechanism to improve the fuel economy. This type is called a variable divide cooling system.

Therefore, the variable divide cooling system is different from a typical cooling system in which a coolant is supplied from a water pump to an engine block and a cylinder head, is cooled by a radiator, and then is re-circulated to the engine.

For example, in comparison with the typical cooling system, the variable divide cooling system has a channel cutoff valve installed at an engine block side, and a channel line connected to the channel cutoff valve. When an operation state of the engine satisfies specific conditions, the channel cutoff valve is controlled so that a flow of a coolant of the engine block side is stagnated. Thereby, the coolant in the engine block rapidly absorbs heat from the engine.

Further, the variable divide cooling system is configured so that the heated coolant passing through the engine block and the cylinder head is supplied to anti-freeze a throttle body and heat a vehicle heater.

In this way, the variable divide cooling system can reduce a friction loss caused by the engine block of a low temperature to improve the fuel economy, and decrease a temperature of the cylinder head by increasing a flow rate of the coolant of the cylinder head side to improve combustion characteristics. To this end, circulation of the coolant of the engine is optimally controlled.

However, the variable divide cooling system reduces performance of an air conditioner due to a change in circulation of the coolant. In detail, the coolant is stagnated in the engine block by operation of the channel cutoff valve, and the flow rate supplied to a heater of a blower that is the air conditioner is reduced. The reduction of the flow rate supplied to the heater decreases heating performance. This leads to the cause of raising customer's complaint, in particular, in winter,

Such a decrease in heating performance is caused by operation conditions of the channel cutoff valve to which only engine conditions such as a load, torque, RPM (revolutions per minute), and a temperature of a coolant are applied.

Therefore, in the variable divide cooling system, there is a limitation in that the channel cutoff valve is operated to change the circulation of the coolant without considering whether the air-conditioner is operated at all.

loom The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art and/or other problems, and the present invention is directed to a method of controlling a variable divide cooling system for a vehicle based on a mode, in which, after driver's will for heating and environmental conditions of the vehicle are comprehensively determined when a flow of a coolant is forcibly stagnated in an engine block, a circulation flow of the coolant is controlled, so that heating requirements are satisfied without degrading heating performance, and a use area is extended by satisfying the heating performance while improvement of basic performances such as engine efficiency and vehicle fuel economy is maintained.

In accordance with various aspects of the present invention, a method of controlling a variable divide cooling system for a vehicle based on a mode may include classifying the mode for circulation control of a coolant of the variable divide cooling system into a heating mode, a warming-up mode, and a cooling mode, and performing the heating mode after an open-air temperature and a coolant temperature are checked when an engine is in a running state, and when a heater blower is turned on.

The heating mode may be performed only when a setting condition of the open-air temperature is satisfied and the coolant temperature may be checked, wherein the setting condition of the open-air temperature may be “open-air temperature<setting value” and the setting value in the setting condition of the open-air temperature may be a temperature at which heating is required. The heating mode may be performed when a setting condition of the coolant temperature is satisfied, wherein the setting condition of the coolant temperature may be “coolant temperature >setting value” and the setting value in the setting condition of the coolant temperature may be a temperature at which the heating is possible

On the heating mode, the coolant flowing out of the engine may flow into the heater blower via a block channel cutoff mechanism without flowing into a radiator, and a water pump may pump the coolant in a water temperature control (WTC) unit and return the coolant to the engine.

The method may further include performing the warming-up mode a setting condition of the open-air temperature is not satisfied or a setting condition of the coolant temperature is not satisfied, and when an operation state of the engine satisfies conditions required to warm up an engine block. Further, the conditions required to warm up the engine block may include a load, torque, and/or revolutions per minute (RPM) of the engine, and/or the coolant temperature.

On the warming-up mode, the coolant flowing out of the engine may be blocked and stagnated in the engine block by a block channel cutoff mechanism, and flow into the heater blower and a WTC unit without flowing into a radiator, and a water pump may pump the coolant from the WTC unit, and return the coolant to the engine.

The method may further include performing the cooling mode when an operation state of the engine does not require the heating mode and the warming-up mode. On the cooling mode, the coolant flowing out of the engine may flow into the heater blower via a block channel cutoff mechanism and a radiator, the coolant flowing out of the radiator may flow into a WTC unit, a water pump may pump the coolant from the WTC unit and return the coolant to the engine.

According to the present invention, heating requirements are satisfied without degrading heating performance when heating is required while an improvement in basic performances such as engine efficiency and vehicle fuel economy is maintained. Thereby, the cause of customer's complaint against the variable divide cooling system is removed, and in particular, a use area of the variable divide cooling system is expended by satisfying the heating performance.

Further, according to the present invention, the heating is required by comprehensively determining driver's will for the heating and environmental conditions of the vehicle. Thereby, a change in engine conditions on which a flow of a coolant should be stagnated in an engine block is not required. In addition, according to the present invention, the change in engine conditions is not required to stagnate the coolant in the engine block. Thereby, a logic for an existing variable divide cooling control is easily improved and updated.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and 1B are a flowchart showing an operation of an exemplary method for controlling a variable divide cooling system for a vehicle based on a mode according to the present invention.

FIG. 2 shows a configuration of an exemplary variable divide cooling system to which an exemplary mode-based control method according to the present invention is applied.

FIG. 3 shows a state in which an exemplary variable divide cooling system according to the present invention is controlled on a heating mode.

FIG. 4 shows a state in which an exemplary variable divide cooling system according to the present invention is controlled on a warming-up mode.

FIG. 5 shows a state in which an exemplary variable divide cooling system according to the present invention is controlled on a cooling mode.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

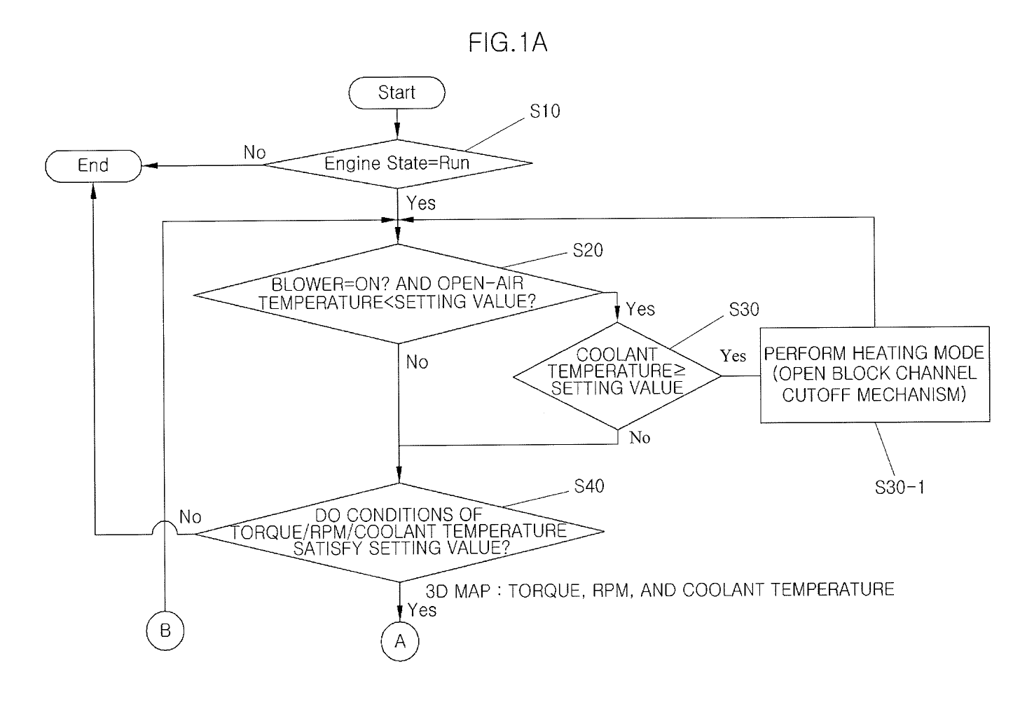

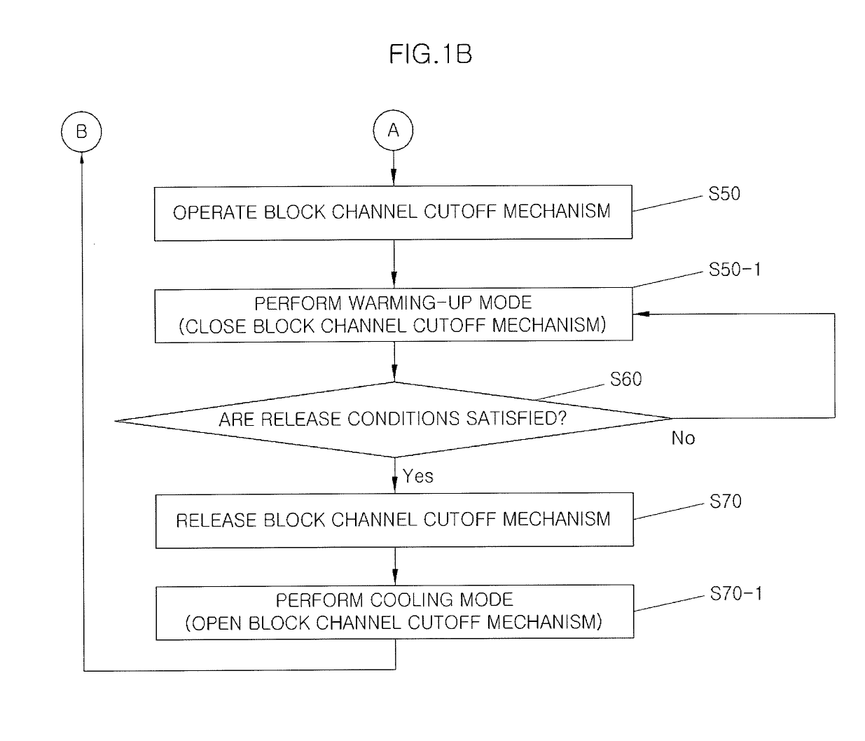

FIG. 1A and 1B are a flowchart showing an operation of a method for controlling a variable divide cooling system for a vehicle based on a mode according to the present embodiment. As shown in FIG. 1A, when an engine enters a running state in step S10, a mode is classified into a heating mode of step S30-1, a warming-up mode of step S50-1, and a cooling mode of step S70-1 according to conditions of a vehicle including the engine. Thus, the variable divide cooling system is controlled by a mode-based control logic.

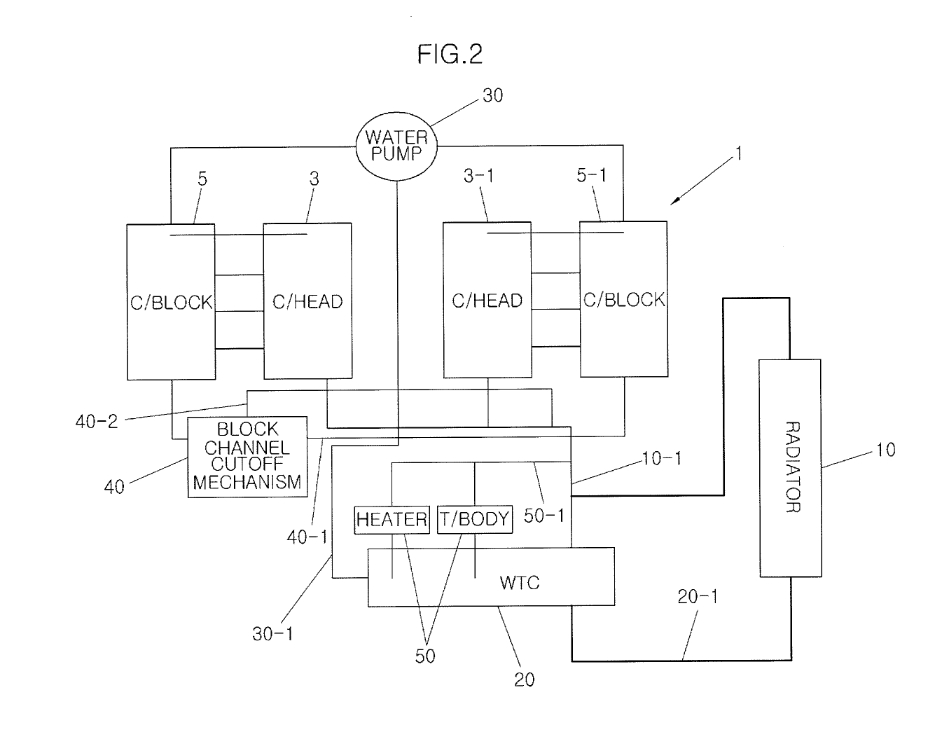

The variable divide cooling system to which the mode-based control logic is applied is exemplified in FIG. 2. As shown in FIG. 2, the variable divide cooling system includes an engine 1 including a left-hand (LH) head 5 into which a coolant is introduced from an LH block 3 and a right-hand (RH) head 5-1 into which a coolant is introduced from an RH block 3-1, a radiator 10 cooling a hot coolant and then sending the coolant to the engine 1, a water temperature control (WTC) unit 20 detecting a temperature of the coolant to control circulation of the coolant, a water pump 30 forcibly circulating the coolant, a block channel cutoff mechanism 40 stagnating the coolant in the LH block 3 and/or the RH block 3-1, and a coolant heat exchange mechanism 50 exchanging heat with the hot coolant.

The block channel cutoff mechanism 40 opens and closes a valve under the control of an engine control unit (ECU) that determines an operation state of the engine based on a load, torque, and revolutions per minute (RPM) of the engine, a temperature of the coolant, and/or other parameters.

The coolant heat exchange mechanism 50 includes a heater of an air conditioner and a throttle valve for controlling an air intake amount.

In addition, in the variable divide cooling system, a coolant circulation line 10-1 connects the engine 1 and the radiator 10, and a WTC connecting line 20-1 branches off from the coolant circulation line 10-1 and connects the radiator 10 and the WTC unit 20. A WTC bypass line 30-1 connects the WTC unit 20 and the water pump 30, and a block connecting line 40-1 connects the block channel cutoff mechanism 40 and the LH block 3, and the block channel cutoff mechanism 40 and the RH block 3-1. A block bypass line 40-2 is connected to the coolant circulation line 10-1, and a coolant branch line 50-1 branches off from the coolant circulation line 10-1 and is connected to the block bypass line 40-2 and the coolant heat exchange mechanism 50.

Referring to FIG. 1A and 1B again, after the engine enters the running state in step S10, the heating mode of step S30-1 is performed when conditions of a heater blower and an open-air temperature are satisfied as in step S20, and then a condition of a coolant temperature is satisfied. Therefore, in the heating mode, after driver's will for heating and environmental conditions of the vehicle are comprehensively determined a circulation flow of the coolant can be controlled.

In step S20, it is determined whether conditions of “heater blower =on” and “open-air temperature <setting value” are satisfied. In this case, the setting value of the open-air temperature refers to an open-air temperature at which the driver requires heating as in the winter season.

In various embodiments, even when the heater blower is turned on, the setting value of the outside air temperature is checked in order to prevent a phenomenon in which variable divide cooling control is always prohibited when the heater blower is operated. This is to prevent an excessive constraint on an improvement in fuel economy, which is the original purpose of the variable divide cooling system, when the vehicle travels in a state in which the heater blower is always operated regardless of the driver's will for the heating.

In step S30, it is determined whether a condition of “coolant temperature≧setting value” is satisfied. In this case, the setting value of the coolant temperature refers to a value more than that of the coolant temperature of the engine which is sufficient for the heating of the vehicle.

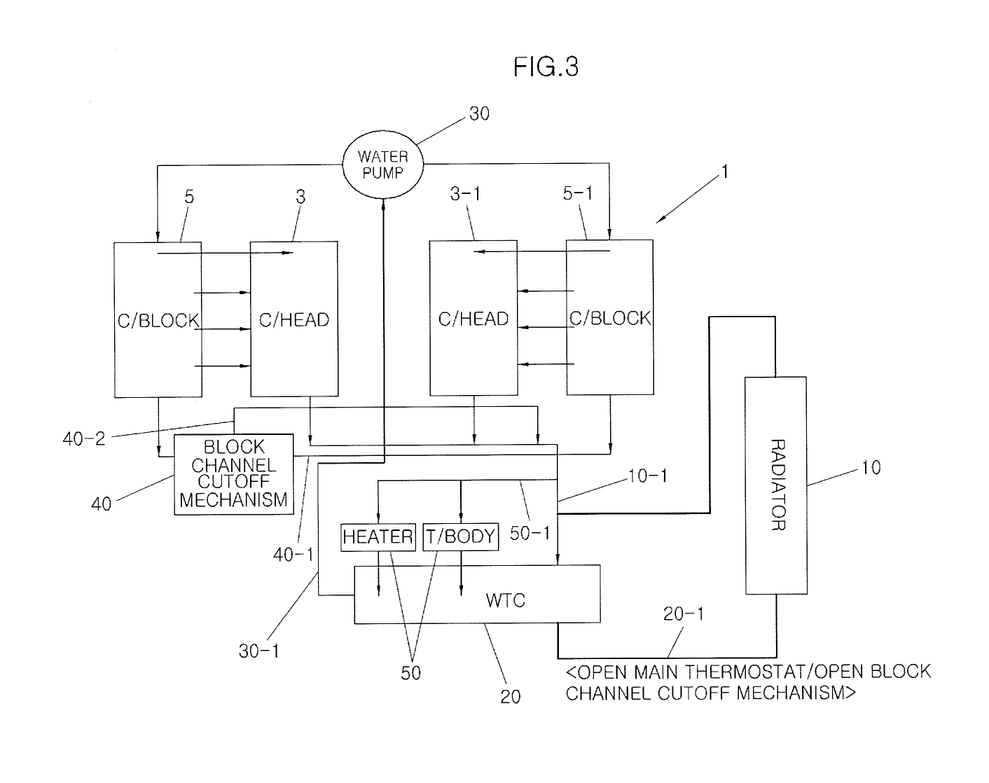

The heating mode of step S30-1 is exemplified in FIG. 3. As shown in FIG. 3, when the variable divide cooling system is operated on the heating mode, the block channel cutoff mechanism 40 is switched to an open state. Thus, a coolant that exceeds a set temperature and flows out of the LH block 3 and the RH block 3-1 is introduced into the block channel cutoff mechanism 40 through the block connecting line 40-1. The coolant that exceeds the set temperature and is introduced into the block channel cutoff mechanism 40 is discharged to the block bypass line 40-2.

Then, the coolant that exceeds the set temperature and is introduced from the block bypass line 40-2 into the coolant circulation line 10-1 flows into the coolant branch line 50-1, and the coolant that exceeds the set temperature and flows into the coolant branch line 50-1 heats the heater of the air conditioner at the coolant heat exchange mechanism 50 and the throttle valve for controlling the air intake amount.

In this case, the water pump 30 forcibly pumps the coolant through the WTC bypass line 30-1. Thereby, the coolant flowing out of the coolant circulation line 10-1 circulates to the engine 1 without passing through the radiator 10.

Referring to FIG. 1 again, in step S40, the operation state of the engine is determined. Step S40 is performed when the conditions of “heat blower=on” and “open-air temperature<setting value” of step S20 are not satisfied, or the condition of “coolant temperature≧setting value” of step S30 is not satisfied.

In this case, condition factors determining the operation state of the engine include a load, torque, and/or RPM of the engine, and/or a coolant temperature. For example, the load, the torque, the RPM, and the coolant temperature are the setting values, and the setting values refer to values of conditions required to pre-heat the engine block.

In step S40, when the conditions of the operation state of the engine are not satisfied, the control of the variable divide cooling system is stopped. However, when the conditions of the operation state of the engine are satisfied, the block channel cutoff mechanism is switched to a closed state as in step S50. As a result, the warming-up mode of step S50-1 is performed.

The warming-up mode of step S50-1 is performed until release conditions (from the closed state to the open state) of the block channel cutoff mechanism is satisfied as in step S60. In this case, the release conditions of the block channel cutoff mechanism refer to the conditions of the load, the torque, the RPM, and the coolant temperature that do not require warming-up of the engine block.

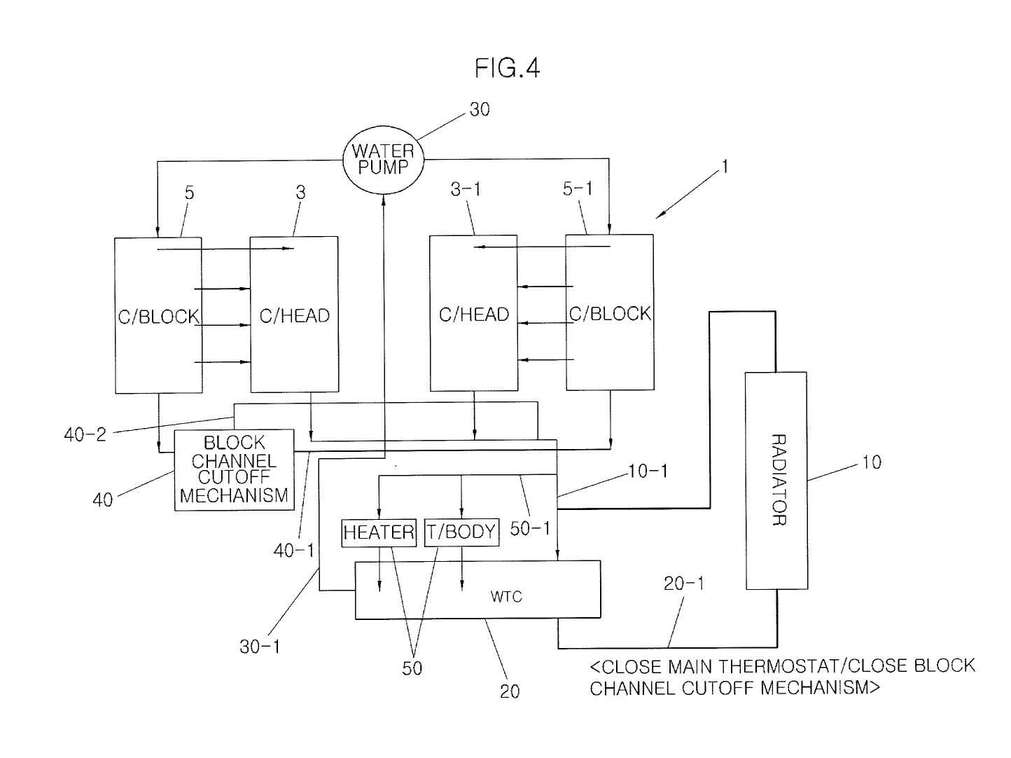

The warming-up mode of step S50-1 is exemplified in FIG. 4. As shown in FIG. 4, when the variable divide cooling system is operated on the warming-up mode, the block channel cutoff mechanism 40 is switched to the closed state. Therefore, the coolant flowing out of the LH block 3 and the RH block 3-1 is not introduced into the block channel cutoff mechanism 40 through the block connecting line 40-1.

As a result, a flow of the coolant flowing into the coolant branch line 50-1 through the block bypass line 40-2 of the block channel cutoff mechanism 40 is not formed. In this case, the water pump 30 forcibly pumps the coolant through the WTC bypass line 30-1, and thereby the coolant flowing out of the coolant circulation line 10-1 circulates to the engine 1 without passing through the radiator 10.

Referring to FIG. 1A and 1B again, in step S70, the release conditions of the block channel cutoff mechanism are satisfied in step S60, and thus the block channel cutoff mechanism is switched from the closed state to the open state. Accordingly, the cooling mode of step S70-1 is performed.

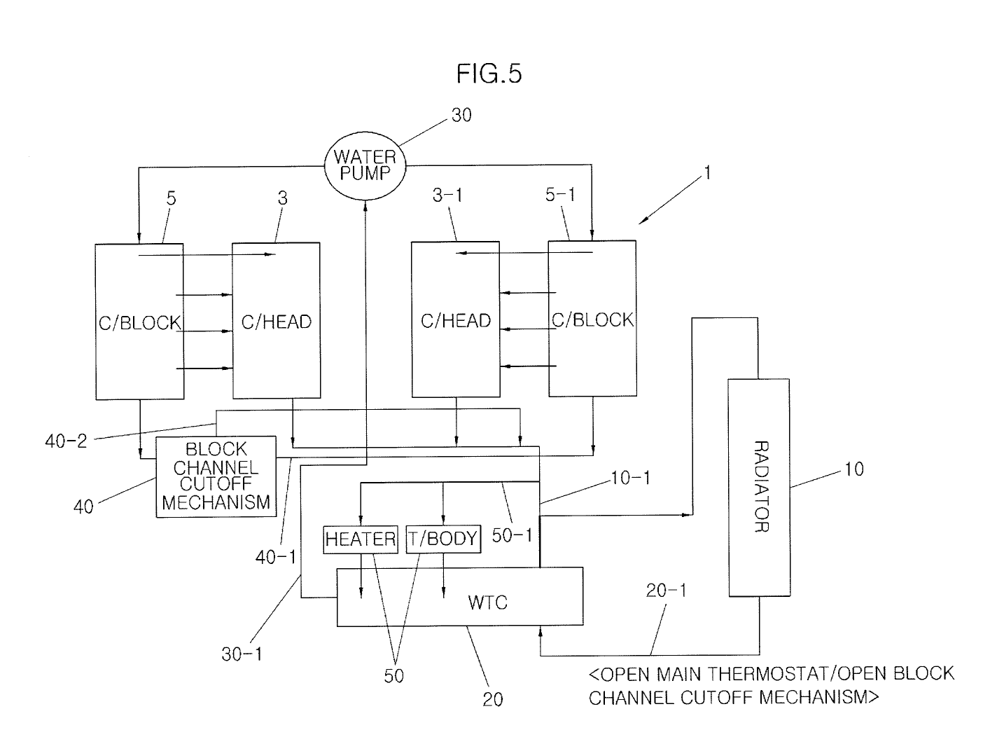

The cooling mode of step S70-1 is exemplified in FIG. 5. As shown in FIG. 5, when the variable divide cooling system is operated on the cooling mode, the block channel cutoff mechanism 40 is switched to the open state. Therefore, a hot coolant flowing out of the LH block 3 and the RH block 3-1 is introduced into the block channel cutoff mechanism 40 through the block connecting line 40-1, and the hot coolant introduced into the block channel cutoff mechanism 40 is discharged to the block bypass line 40-2.

Then, the hot coolant introduced from the block bypass line 40-2 into the coolant circulation line 10-1 is introduced into the coolant branch line 50-1, and the hot coolant flows into the coolant heat exchange mechanism 50 through the coolant branch line 50-1 and simultaneously into the radiator 10 connected to the coolant circulation line 10-1.

As a result, the hot coolant flowing out of the engine 1 is converted into a cold coolant by heat exchange of the radiator 10, and the cold coolant is discharged from the radiator 10 to the WTC unit 20 through the WTC connecting line 20-1. Thus, the water pump 30 forcibly pumps the cold coolant through the WTC bypass line 30-1, and thereby the cold coolant circulates to the engine 1.

As described above, in the method of controlling a variable divide cooling system for a vehicle based on a mode in accordance with the present embodiment, when the engine is in a running state, and when the heater blower 50-1 is turned on, the open-air temperature and the coolant temperature are checked, and then the heating mode is performed. In the heating mode, the coolant flowing out of the engine 1 flows into the heater blower 50-1 via the block channel cutoff mechanism 40. Thereby, the heating requirements are satisfied without degrading the heating performance when the driver desires the heating. In particular, a use area can be extended by satisfying the heating performance while improvement of basic performance such as engine efficiency and vehicle fuel economy is maintained.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling a variable divide cooling system for a vehicle based on a mode, the method comprising:
classifying the mode for circulation control of a coolant of the variable divide cooling system into a heating mode, a warming-up mode, and a cooling mode; and
performing the heating mode after an open-air temperature and a coolant temperature are checked when an engine is in a running state, and when a heater blower is turned on.

2. The method of claim 1, wherein the heating mode is performed only when a setting condition of the open-air temperature is satisfied and the coolant temperature is checked, wherein the setting condition of the open-air temperature is “open-air temperature <setting value” and the setting value in the setting condition of the open-air temperature is a temperature at which heating is required.

3. The method of claim 2, wherein the heating mode is performed when a setting condition of the coolant temperature is satisfied, wherein the setting condition of the coolant temperature is “coolant temperature >setting value” and the setting value in the setting condition of the coolant temperature is a temperature at which the heating is possible.

4. The method of claim 1, wherein, on the heating mode, the coolant flowing out of the engine flows into the heater blower via a block channel cutoff mechanism without flowing into a radiator, and a water pump pumps the coolant in a water temperature control (WTC) unit and returns the coolant to the engine.

5. The method of claim 1, further comprising:
performing the warming-up mode when a setting condition of the open-air temperature is not satisfied or a setting condition of the coolant temperature is not satisfied, and when an operation state of the engine satisfies conditions required to warm up an engine block.

6. The method of claim 5, wherein the conditions required to warm up the engine block include a load, torque, and/or revolutions per minute (RPM) of the engine, and/or the coolant temperature.

7. The method of claim 5, wherein, on the warming-up mode, the coolant flowing out of the engine is blocked and stagnated in the engine block by a block channel cutoff mechanism, and flows into the heater blower and a WTC unit without flowing into a radiator, and a water pump pumps the coolant from the WTC unit and returns the coolant to the engine.

8. The method of claim 1, further comprising:
performing the cooling mode when an operation state of the engine does not require the heating mode and the warming-up mode.

9. The method of claim 8, wherein, on the cooling mode, the coolant flowing out of the engine flows into the heater blower via a block channel cutoff mechanism and a radiator, the coolant flowing out of the radiator flows into a WTC unit, a water pump pumps the coolant from the WTC unit and returns the coolant to the engine.
